(19) United States
(12) Patent Application Publication
(10) Pub. No.: US 2008/0257923 A1
(43) Pub. Date: Oct. 23, 2008

(54) Storage System For Motor Vehicles

(75) Inventor: James D. DalPizzol, Clinton Township, MI (US)

Correspondence Address: GROSSMAN, TUCKER, PERREAULT & PFLEGER, PLLC, 55 SOUTH COMMERICAL STREET, MANCHESTER, NH, 03101, US

(73) Assignee: COLLINS & AIKMAN CORPORATION, Southfield, MI (US)

(21) Appl. No.: 11/938,021

(22) Filed: Nov. 9, 2007

Related U.S. Application Data
(60) Provisional application No. 60/865,086, filed on Nov. 9, 2006.

(51) Int. Cl. B60R 7/00; B60R 9/00

(52) U.S. Cl. 224/281; 224/400

(57) ABSTRACT

A modular system of storage is provided to tailor a vehicle to multiple activities by providing a plurality of storage modules which may be interchanged, instantly transforming the interior of the vehicle to a more efficient and customized storage condition. The modules may then be conveniently stored, for instance, in a garage and pre-packed to support a specific event or activity, then attached in a designated location in the interior vehicle trim. The modules may be merged together to form relatively larger modules and be designed to fit into a plurality of recesses/openings in the vehicle for transport (e.g. the cargo space or a floor recess) vs. immediate use locations (e.g. the console, glove box area, door panels, headliners, seat backs, etc.).

### CROSS-REFERENCE TO RELATED APPLICATIONS

This application claims priority to U.S. Provisional Application No. 60/865,086, filed Nov. 9, 2006.

### FIELD

The present disclosure relates to a system of modules for the storage of items inside and outside a motor vehicle. More particularly, the present invention relates to a system of modules which may be customizable, interchangeable and reconfigurable that may also be integrated into vehicle trim panels.

### BACKGROUND

Typically, an American family today may have more than one vehicle and one of those vehicles may be a sports utility vehicle (SUV), minivan or cross-over vehicle which may be used primarily for transporting the family to different events. This may include commuting to the office, transporting children to recreational events, traveling to visit or vacation, or just running errands. What is common is the presence of multiple family members and the need to store a wide variety of items having a particular theme. It is not unusual for today's family to have one member practicing baseball, another soccer, another gymnastics or swimming; each needing related equipment on a specific daily or weekly schedule.

Further, the theme may change at numerous times during the day, for instance in the case of “soccer moms” or parents who have part-time jobs and must juggle their schedules with that of their children in school. All of this may provide a need for convenient and reconfigurable storage in a vehicle, which may also be used outside of the vehicle.

### SUMMARY

The present disclosure is directed at a system of reconfigurable, interchangeable and customizable storage modules which may be designed to fit into a designated area in the vehicle, yet be portable for storage in the home without unpacking, etc. The storage modules may releasably engage within a trim panel and may be readily connected to form relatively larger modules for more efficient storage. The modules may be designed to fit and/or be concealed within a trim panel, and not be visible to the vehicle occupants. The modules may include fixtures which are indexed to engage with the vehicle and may therefore be powered by the vehicle to provide heating and/or cooling.

In one exemplary embodiment, the modules may be molded plastic shapes which may fit into an opening in a center console and provide storage for items related to such activities as entertainment, to food storage or a picnic, to playing a specific sport, to providing infant care, or to tool storage, or a portable office. Such modules may also be configured to store elsewhere in the vehicle, or in the home, when not in immediate need, eliminating the need to repack the stored items each time they are to be used.

Modules may be designed to fit at any convenient location in the vehicle for easy access and transport, including but not limited to the console, glovebox area, door panels, cargo area, floor recesses, headliners, seatbacks and so forth. Thus, the modules may be configured to fit into an opening or depression in one of these panels/areas and aesthetically blend into the appearance (color/texture/finish) of the vehicle interior.

The modules may also be configured to fit into openings in alternate locations in the vehicle when not intended for immediate use, for instance to store the modules in the cargo area or in a floor recess.

The modules may each include a strap or handle for ease of transport, the handle being foldable and/or removable.

### BRIEF DESCRIPTION OF THE DRAWINGS

These and other objects, features and advantages of the present invention will become apparent to those skilled in the art upon reference to the following written description and accompanying drawings in which:

FIG. 1 is a perspective view of an exemplary storage module according to the present invention.

FIG. 2 is a perspective view of the storage module of FIG. 1 in a stored condition.

FIG. 3 is a perspective view of the storage module of FIG. 1 with the top access panel open.

### DETAILED DESCRIPTION

The present disclosure is described more fully hereinafter with reference to the accompanying drawings, in which preferred embodiments of the invention are shown. This disclosure, may, however, be embodied in many different forms and should not be construed as limited to the embodiments set forth herein; rather, these embodiments are provided so that this disclosure will be thorough and complete, and will fully convey the scope of the invention to those skilled in the art.

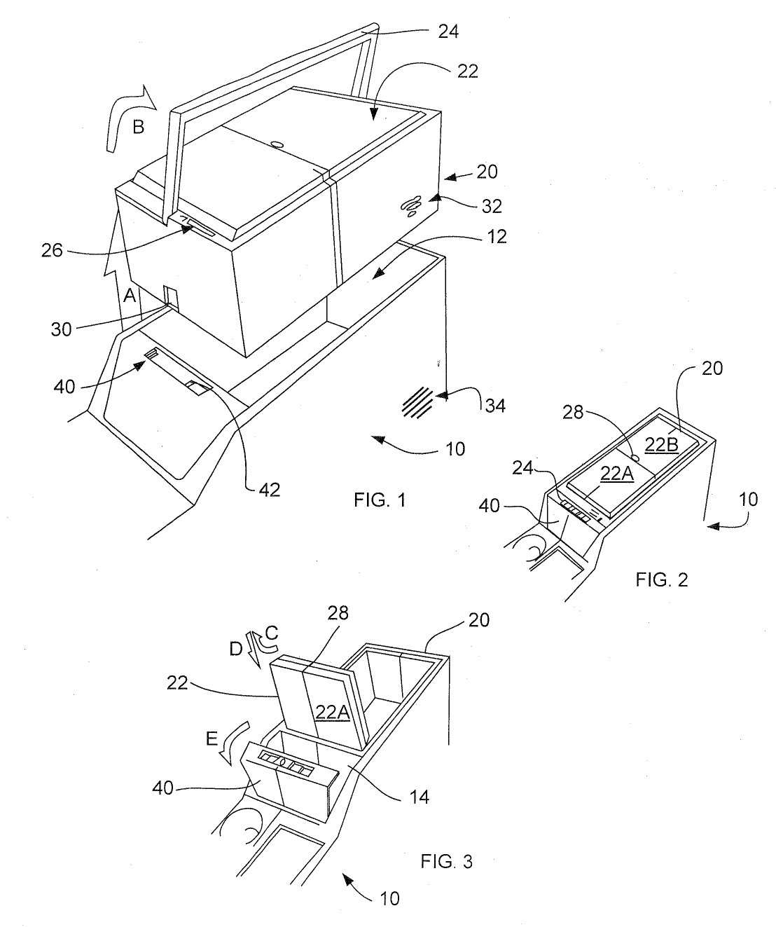

FIG. 1 is a perspective view of what may be termed a “Pick and Pack” storage module according to the present invention. In this exemplary embodiment, the module 20 may be molded of plastic and substantially rectangular in shape and fit into the area of a console 10 in a vehicle. Such a console 10 may include an opening 12 shaped and sized to accept the module 20 for secure storage and easy accessibility. In FIG. 1 the module 20 is shown just as it is being extracted (Arrow A) from within the opening 12. A handle 24 may be used for carrying the module to and from the vehicle or the home. The handle 24 may be foldable (Arrow B) as shown or removable and may comprise one or more rigid members or a strap.

In this exemplary embodiment, the storage module 20 is depicted as a hot/cold food storage container which may include a set of controls 26 and a vent 32. The module vent 32 may align or engage with a corresponding vent 34 in the side of the console 10. The console may also include a fan or similar device to draw air form the module and through the vents.

One or more locating features 30 in the outer wall of the module 20 may align with a cooperating feature (not shown) on an inside wall of the opening 12 in the console 10 to assure that the module 20 is oriented correctly and located securely in the opening 12. Locating feature 30 may include a plug receptacle and therefore provide a power receiving point so that the module 20 may therefore include electric heating or cooling capability.

A lid 40 for a mini-bin in the console 10 may be located at one end, with a latch 42, so that a storage space 14 for smaller items may be accessed by pivoting the lid 40 forward (see Arrow E in FIG. 3). The console may also include other storage devices such as trays and cup holders.

Also shown in FIG. 1 is a lid 22 for the module 20. In this exemplary embodiment the lid may be soft, or padded, to provide a surface for resting the arm while riding or driving.

FIG. 2 is perspective view showing the exemplary storage module 20 in place in console 10 with the handle 24 folded down. Upon locating the module via locating feature 30 in the console opening 12, and as alluded to above, there may also be electrical contact made between connectors (not shown) on the module 20 and in a wall of the opening 12 to provide power to the module. This may include power to drive heating or cooling devices which are built into the module or power for an entertainment based module (DVD, iPod, MP3 player, etc.) or an office-based module (to power a laptop, phone, facsimile machine, printer, copier, etc). Actuation of the handle to a flat condition may lock the module in the opening and/or assure that electrical contact is made between connectors.

FIG. 2 also illustrates a latch 28 for the lid of the module 20.

FIG. 3 is a third perspective view of the exemplary storage module 20, in this case a hot/cold food storage module, in an open for-use condition. In this view, a folding top 22 is illustrated where upon activation of the latch 28, panel 22A may be lifted up, pivoting around a hinge at one end of the module 20 (see Arrow C). The other panel 22B of the lid 22 is hinged to panel 22A and may fold down (Arrow D) to allow easy access to the interior of the module 20. It is contemplated that a variety of designs of sliding or pivoting lids may be used, including lids which may be retractable down between the edges of the console 10 and the module 20.

For the purpose of illustration, a hot/cold food module has been described herein. However, it is contemplated that the storage modules of the present invention could have purposes or themes which may include, but are not limited to, infant care (diaper changing/storage/disposal, food warming, lotions and powders, etc.); entertainment (T.V., DVD, PM3 player, iPod, video games, etc.); office (printer, facsimile, phone, P.D.A., navigation system, paper/CD disc filing system, recharging outlet, etc.); car care (cleaning supplies, vacuum cleaner, trash storage, compactor, etc.); vehicle safety and maintenance (tools, flares, flashlight, cables, rain gear, medical kit, etc.); sports gear (baseball, softball, soccer, skating, karate, gymnastics, swimming, musical instruments, etc.); personal care (cosmetics, hygiene products, razors, etc.); recreational events (beach, camping, picnic, etc.) and gaming (toys, board games, reading and writing implements, etc.).

The size of the modules may be such that they are convenient to be carried when loaded with equipment, etc. With a standard size for a module, say in the console area, smaller modules may be combined or linked together to fill the space. For side trim, seatback or headliner locations, the modules may have a flatter, longer profile than for a glove box or a console location.

Features may be included on the exterior of each module to allow connecting modules together for efficiency and stability in storage. Further, wheels and one or more handles may be included to ease the load of carrying the module.

It is contemplated that the modules may be molded of plastic to provide durability and light weight and may include insulating materials to maintain desired temperatures within. Further, the exterior of the modules may be finished to coordinate or contrast aesthetically with the surrounding interior panels in terms of color, gloss, texture, etc.

While the exemplary embodiment described above includes an opening in a console into which a storage module would fit, it is further contemplated that the module may mechanically attach to brackets in the wall or the floor of the vehicle in various locations (between seats, in place of seats, in floor panels, etc.) and not require an opening in a trim panel for location.

The “Pick and Pack” modular system of storage tailors a vehicle to multiple purposes by providing a plurality of storage modules having different themes which may be interchanged, instantly transforming the interior of the vehicle to meet the distinctly different needs of each of the purposes. The modules may be stored, for instance, in the garage and pre-packed to support a specific event or activity, then placed into a tailored location in the vehicle to provide the accessories to carry out the purpose. The module may be customized, interchangeable, reconfigured or even merged together to form larger modules out of smaller ones or to connect the modules for efficient storage. The modules may also be designed to fit into a plurality of recesses/openings in the vehicle for transport (in cargo space or a floor recess) vs. immediate use (in console, glove box area, door panels, headliners, seat backs, etc.).

The description and drawings illustratively set forth an exemplary embodiment. We intend the description and drawings to describe this embodiment and not to limit the scope of the invention. Therefore, one may practice the invention otherwise than as the description and drawings specifically show and describe.

What is claimed is:

1. A multipurpose storage system for storing a set of articles both inside and outside of a vehicle, comprising:
an opening or depression formed in a trim panel in said vehicle, said opening or depression including a first locating feature;
a first portable molded plastic storage module including a lid and a handle, said module configured to fit within said opening or depression wherein said handle of said module is configured to be actuated to lock said module in said opening or depression;
wherein said module includes a second locating feature which is complementary to said first locating feature to releasably engage, orient and locate said module in said opening or depression;
wherein said first locating feature and second locating feature each include electrical connectors to supply electrical power from said vehicle to said module.

2. The multipurpose storage system of claim 1 wherein said lid may be soft and/or padded.

3. The multipurpose storage system of claim 1 wherein said module may contain one or more trays and/or cup holders.

4. The multipurpose storage system of claim 1 wherein said handle is configured to actuate to provide that electrical contact is made between said electrical connectors.

5. The multipurpose storage system of claim 1 wherein said module further includes controls for said electrical power.

6. The multipurpose storage system of claim 1 wherein said module is capable of heating or cooling articles stored therein.

7. The multipurpose storage system of claim 1 wherein said module comprises an insulating material.

8. The multipurpose storage system of claim 1 wherein said module further includes one or more wheels for transporting said module outside said vehicle.

9. The multipurpose storage system of claim 1 wherein said module comprises a plurality of modules configured to fit within said opening.

10. The multipurpose storage system of claim 1 wherein said trim panel comprises a console, a door panel, a seat back, a headliner, a cargo space, a glove box or a floor covering.

11. A customizable, reconfigurable, interchangeable and portable storage device for storing a set of articles, both inside and outside of a vehicle, comprising:
a molded plastic storage module including a lid and a handle, said module configured to fit within an opening or depression in a trim panel in a vehicle, wherein said handle of said module is configured to be actuated to lock said module in said opening or depression;
wherein said module includes a locating feature to releasably engage, orient and locate said module in said opening or depression; and
wherein said locating feature includes an electrical connector to accept electrical power from said vehicle to said module.

12. The portable storage device of claim 11 wherein said handle is configured to actuate to provide that electrical contact is made between said electrical connector of said device and a vehicle electrical connector.

13. The portable storage device of claim 11 wherein said module further includes controls for said electrical power.

14. The portable storage device of claim 11 wherein said module is capable of heating or cooling articles stored therein.
